(19) United States
(12) Patent Application Publication
(10) Pub. No.: US 2026/0318769 A1
(43) Pub. Date: Oct. 15, 2026

(54) METHOD AND SENSOR DEVICE FOR ACOUSTICALLY MONITORING A MEASURING POINT AT A FITTING THROUGH WHICH FLUID FLOWS AND CORRESPONDING SENSOR DEVICE

(71) Applicant: GESTRA AG, Bremen (DE)

(72) Inventors: Sergej JANZEN, Schiffdorf (DE); Holger SCHRÖTER, Achim (DE); Jürgen KLATTENHOFF, Delmenhorst (DE)

(21) Appl. No.: 19/106,565

(22) PCT Filed: Sep. 1, 2023
(86) PCT No.: PCT/EP2023/074012

§ 371 Date: Feb. 25, 2025

(30) Foreign Application Priority Data
Sep. 2, 2022 (DE) 10 2022 122 295.0

(51) Int. Cl. G01M 3/24; F16T 1/48; G01J 5/00

(52) U.S. Cl. CPC G01M 3/24; F16T 1/48; G01J 5/0037

(57) ABSTRACT

A method for acoustically monitoring a measuring point at a fitting through which fluid flows, particularly a condensate drain, includes:
detecting an ambient noise sound emission in a surrounding area of the measuring point; detecting a structure-borne sound emission emitted by the measuring point; determining a first frequency spectrum of the ambient noise sound emission for a first frequency range and at least one further frequency spectrum for at least one further frequency range; determining a first frequency spectrum of the structure-borne sound emission for the first frequency range and at least one further frequency spectrum for the at least one further frequency range; determining a first characteristic number from the frequency spectrums in the first frequency range; determining a further characteristic number from the further frequency spectrums in the further frequency range, wherein the characteristic numbers form a characteristic pattern which determines an operating state of the condensate drain.

The invention relates to a method for acoustically monitoring a measuring point at a fitting through which fluid flows, in particular at a condensate drain. The invention further relates to a sensor device for acoustically monitoring a measuring point at a fitting through which fluid flows, a computer program as well as a computer-readable medium.

Methods for acoustically monitoring a measuring point at a fitting through which fluid flows, in particular at a condensate drain, are known from the prior art. Measuring devices are known for this purpose, which are placed directly onto a condensate drain by means of a measuring tip. Such a measuring device measures the intensity of the generated structure-borne sound of the condensate drain, in particular in the ultrasonic frequency range, and derives the set operating state of the analyzed condensate drain therefrom. In the case of condensate drains, it is of high importance thereby to detect maloperations at an early stage. For example, an unwanted loss of steam, which is associated with specific acoustic features, which are detected in particular on the basis of the emitted structure-borne sound, is such a maloperation. Even though the contact-based measuring instruments known from the prior art have proven themselves, there is nonetheless room for improvement.

Due to the fact that condensate drains are often installed in complex steam-conveying plants, it occasionally turns out to be challenging to establish indirect contact with the condensate drain, and to attach the measuring instruments known from the prior art to the condensate drain for measuring purposes. In this case, there may be a risk potential for the corresponding user, who has to get very close to a condensate drain, which may be very hot.

In light of the foregoing, the invention was based on the object of further developing a method for acoustically monitoring a measuring point at a fitting through which fluid flows or a corresponding sensor device, respectively, to the effect that the disadvantages found in the prior art are eliminated as much as possible. A method and a sensor device is to in particular be specified, which increase the reading comfort for the user and which can furthermore also be used safely at locations, which are difficult to access, and very hot condensate drains.

In the case of the method of the above-mentioned type, the object is solved according to the invention by means of the steps of: detecting an ambient noise sound emission in a surrounding area of the measuring point, detecting a structure-borne sound emission, which is emitted by the measuring point, determining a first frequency spectrum of the ambient noise sound emission for a first frequency range, determining at least one further frequency spectrum of the ambient noise sound emission for at least one further frequency range, determining a first frequency spectrum of the structure-borne sound emission for the first frequency range, determining at least one further frequency spectrum of the structure-borne sound emission for the at least one further frequency range, determining a first characteristic number from the frequency spectrums in the first frequency range, determining a further characteristic number from the further frequency spectrums in the further frequency range, wherein the characteristic numbers form a characteristic pattern, determining an operating state of the condensate drain on the basis of the characteristic pattern.

The invention uses the knowledge that, based on the mentioned method steps, an operating state of the fitting or of the condensate drain, respectively, can be determined independently of the necessity of a contact-based structure-borne sound measurement. This is possible in particular in that ambient noises of the typically relatively weak structure-borne sound useful signal of a condensate drain are detected and are considered during a corresponding evaluation. A characteristic pattern, which serves as indicator for the set operating state of the condensate drain, can be determined in this way.

In the present case, a characteristic pattern is understood to be a pattern, which is formed from individual characteristic numbers, which are derived from a respective frequency spectrum, whereby the characteristic pattern allows drawing a conclusion to an operating state of the fitting. The frequency ranges preferably do not have an overlap with regard to the selected frequencies and are optionally arranged adjacent to one another. The frequency ranges preferably lie in a total frequency range of 0 kHz to 100 kHz. The frequency ranges preferably have a range width of 1 kHz to 30 kHz, in particular 10 kHz to 25 kHz.

According to a preferred embodiment, detecting the ambient noise sound emission and detecting the structure-borne sound emission takes place in a contact-free manner. A contact-free measurement is to thereby be understood as that measurement, during which there is no or there does not have to be a direct contact, respectively, between the measuring means, for instance a measuring tip, and the fitting or the condensate drain. By performing the contact-free measurements, the flexibility of the measurement data acquisition is increased for the user on the one hand, and it is simultaneously avoided that this user has to step into the immediate vicinity of the condensate drain, which is to be preferred with regard to the accessibility as well as the health protection due to high temperatures.

According to a preferred embodiment, the ambient noise sound emission is detected at a first distance from the measuring point, and the structure-borne sound emission at a second distance from the measuring point, wherein the second distance is smaller than the first distance. The first distance from the measuring point is preferably 10 cm to 30 cm, in particular 20 cm. The second distance from the measuring point is 1 cm to 10 cm, in particular 5 cm. In other words, a measurement of the ambient noise sound emission, also referred to as profile measurement, for detecting ambient noises thus preferably takes place at a distance of in particular 20 cm from the fitting or the condensate drain, respectively. The actual useful signal measurement in the form of a structure-borne sound emission is performed subsequently, preferably in a second step, at a distance of in particular 5 cm from the condensate drain. Frequency spectrums are then determined from the detected measuring signals and a pattern, which is characteristic for an operating state of the fitting, is determined therefrom.

According to a preferred embodiment, the method further comprises the steps of: determining a first difference function from the first frequency spectrum of the ambient noise sound emission and from the first frequency spectrum of the structure-borne sound emission, determining at least one further difference function from the further frequency spectrum of the ambient noise sound emission and the further frequency spectrum of the structure-borne sound emission, determining the first characteristic number on the basis of the first difference function, determining the further characteristic number on the basis of the further difference function.

The invention is further developed in that the method has the steps of: determining a first integer of the first difference function, determining at least one further integer of the further difference function, determining the first characteristic number on the basis of the first integer, determining the further characteristic number on the basis of the further integer. In particular the areas formed by the difference functions of the frequency spectrums are used in this way for the frequency ranges. This has turned out to be particularly suitable for determining the characteristic pattern for identifying the operating state of the fitting or of the condensate drain, respectively.

Determining an operating state of the condensate drain on the basis of the characteristic pattern preferably comprises at least one of the following operating states: normal operation of the condensate drain, defect of the condensate drain.

The method is further developed by means of the step of: quantitatively determining a derived steam loss and/or condensate amount on the basis of the characteristic pattern. The operating state of the condensate drain is determined in this way on the basis of the characteristic pattern and/or the derived steam loss and/or condensate amount is estimated on the basis of the characteristic pattern. Determining the condensate amount preferably takes place in a frequency range of 0 kHz to 20 kHz. Determining the steam loss amount preferably takes place in a frequency range of 40 kHz to 70 KHz.

The method is further developed by means of the step of: providing or detecting a temperature of the condensate drain, in particular at the measuring point, wherein determining the operating state and/or the derived steam loss and/or condensate amount takes place on the basis of the characteristic pattern and of the temperature. The additional consideration of the temperature when determining the operating state or the steam loss and/or condensate amount, respectively, has proven to be suitable for improving the accuracy when determining the operating state or the derived stream loss and/or condensate amount, respectively.

The method is further developed in that determining the operating state and the derived steam loss and/or condensate amount from the characteristic pattern takes place on the basis of machine learning, in particular using a pattern recognition. A neuronal network is preferably trained with training data, which correlates the characteristic pattern with an operating state or a derived steam loss and/or condensate amount of a condensate drain of a certain type. After training the neuronal network, the latter can be used to determine the respective operating state or the derived steam loss and/or condensate amount, respectively, for a corresponding condensate drain type or a group of condensate drains from the characteristic pattern.

The invention has been described above with reference to a method. In a further aspect, the invention relates to a sensor device for acoustically monitoring a measuring point at a fitting through which fluid flows, in particular at a condensate drain. With regard to the sensor device, the invention solves the above-identified task in that said sensor device has a sound sensor, which is configured to sense an ambient noise sound emission and a structure-borne sound emission, which is emitted by the measuring point, in a contact-free manner, and a control device, which is connected to the sound sensor so as to carry data, wherein the control device is configured to carry out the method according to one of the above exemplary embodiments. The sensor device utilizes the same advantages and preferred embodiments as the method according to the invention. In this regard, reference is made to the above statements and the content thereof is included here.

According to a preferred embodiment, the sound sensor is formed as broadband microphone, in particular as ultrasonic microphone. Due to the fact that the characteristic sound frequencies, which allow drawing conclusions to the operating state of the condensate drain, in particular lie in the ultrasonic range, the sound sensor is preferably formed as ultrasonic microphone. According to a preferred embodiment, the sensor device is formed as mobile device. The device can be brought along particularly well by the user in this way and can also be used in the case of confined spaces.

According to a preferred embodiment, the sensor device has a display means, in particular a display, which is configured to display the operating state of the fitting and/or the steam loss and/or condensate amount. The operator obtains the desired information about the state of the fitting or of the condensate drain, respectively, directly on location in this way.

The invention is further developed in that the sensor device has a light source for illuminating the measuring point or the condensate drain, respectively. The detectability or the correct positioning of the sensor device, respectively, at the measuring point of the condensate drain is simplified in this way at locations, which are difficult to access and which are dark. According to a preferred embodiment, the sensor device has a distance meter, in particular a laser distance meter. The correct distancing of the sensor device from the measuring point for carrying out the ambient noise sound emission or the structure-borne sound emission, respectively, can be simplified and monitored in this way.

According to a preferred embodiment, the condensate drain or the measuring point, respectively, has a marking, which simplifies a correct performance of the measurement. The marking is preferably formed as QR code or barcode, whereby the sensor device has a respective corresponding scanner. For instance, the type of the condensate drain can be linked directly to the collected measured values in this way. Determining the characteristic pattern or the operating state, respectively, can furthermore be adapted directly to the detected condensate drain type. According to an alternative embodiment, near field communication (NFC) is used for identifying the condensate drain.

The sensor device is further developed in that it has a temperature sensor, in particular an infrared thermometer, wherein the temperature sensor is configured to sense a temperature of the condensate drain, in particular to sense it in a contact-free manner, and wherein the temperature sensor is connected to the control device so as to carry data. As specified, the use of a temperature sensor, which likewise provides for a contact-free measurement, has turned out to be preferred for increasing the measuring accuracy or the determining accuracy, respectively, of the operating state of the fitting and of the steam loss and/or condensate amount.

The control device is preferably connected to a communication interface so as to carry data. The communication interface is in particular configured to wirelessly communicate with a cloud, a mobile device, or an external network or computer, respectively, via a wireless network. The measurement data can be transmitted in this way in real time or with a time delay to a corresponding system and is available and visible in this way, for example in a central plant control and monitoring system.

In a further aspect, the invention relates to a computer program comprising commands, which have the effect that a sensor device formed according to one of the above exemplary embodiments carries out the method according to one of the above exemplary embodiments. In a further aspect, the invention relates to a computer-readable medium, on which the computer program according to the above exemplary embodiment is stored. The computer program and the computer-readable medium utilize the same advantages and preferred embodiments as the method according to the invention and the sensor device according to the invention, and vice versa. With regard to this, reference is made to the above statements, and the content thereof is included here.

The invention will be described in more detail below and on the basis of a preferred exemplary embodiment with reference to the enclosed figures, in which:

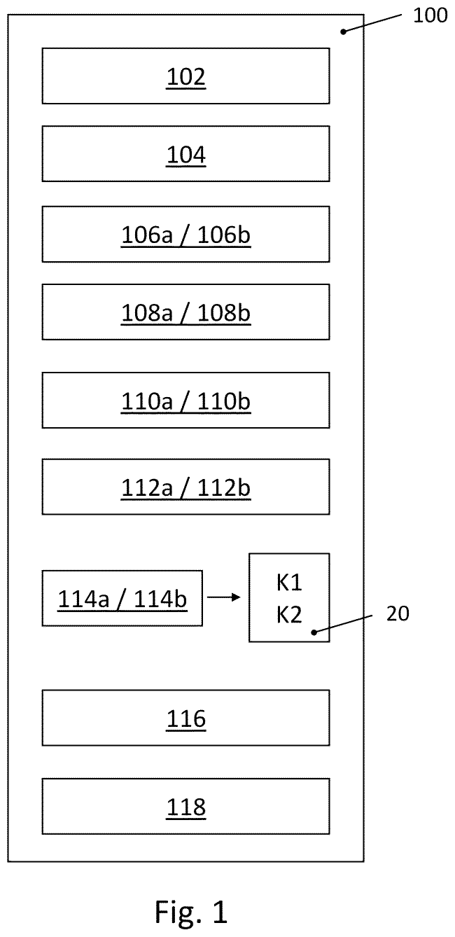

FIG. 1 shows a block diagram of a method according to the invention;

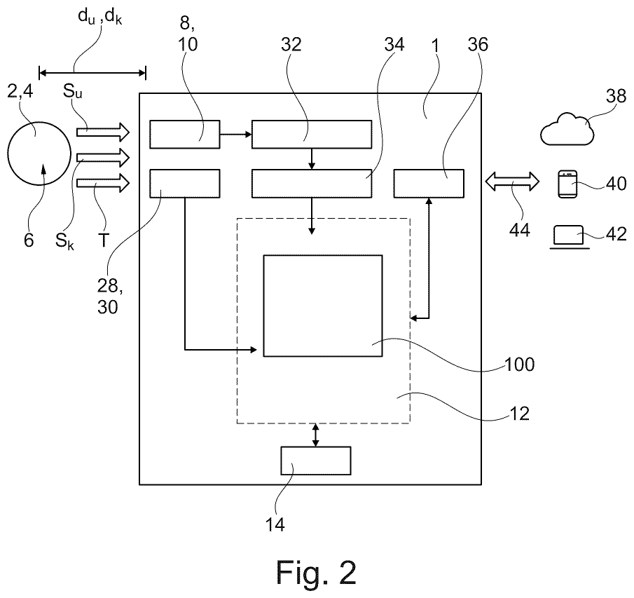

FIG. 2 shows a schematic illustration of a sensor device according to the invention in a schematic illustration;

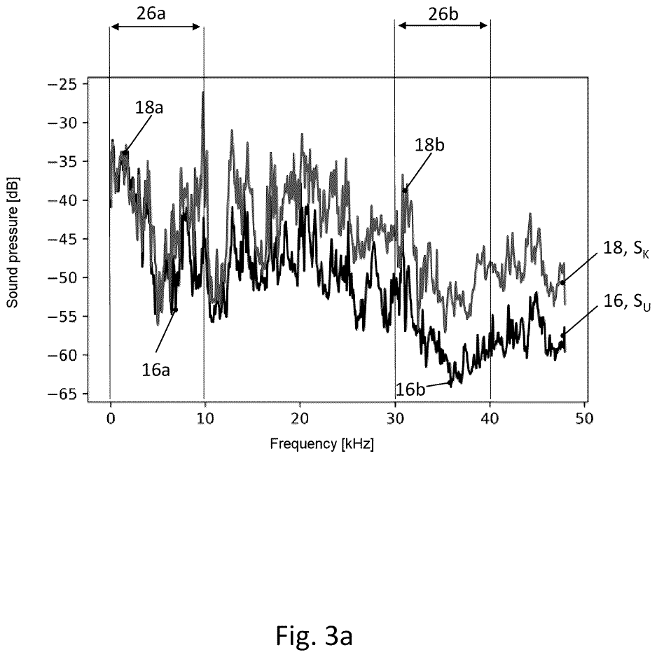

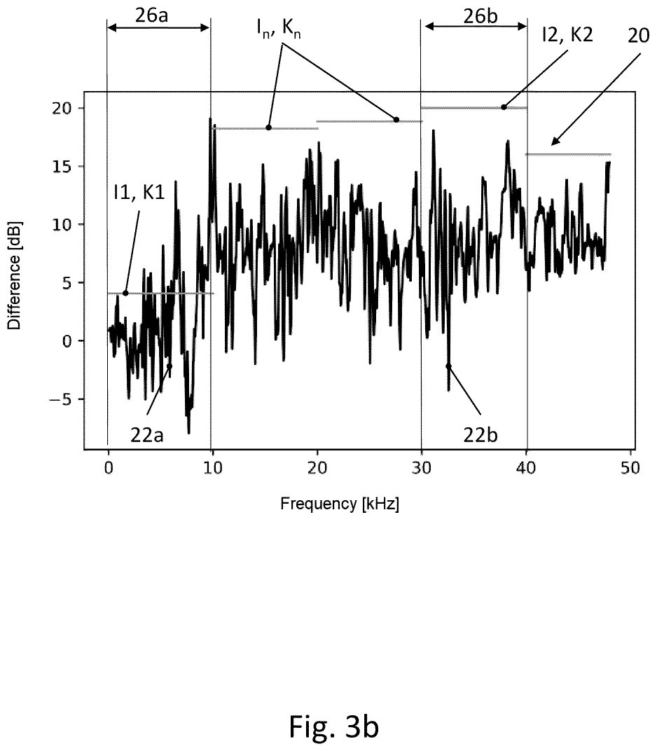

FIG. 3a shows exemplary frequency spectrums of an ambient noise sound emission and a structure-borne sound emission;

FIG. 3b shows a difference function formed from the frequency spectrums of FIG. 3a as well as a characteristic pattern of the difference function;

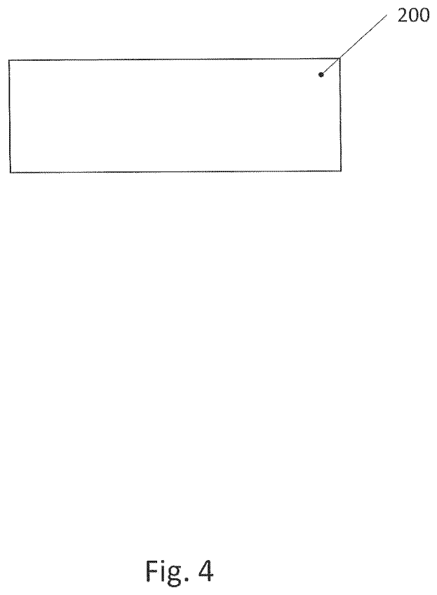

FIG. 4 shows an exemplary embodiment of a computer program according to the invention in a schematic illustration; and

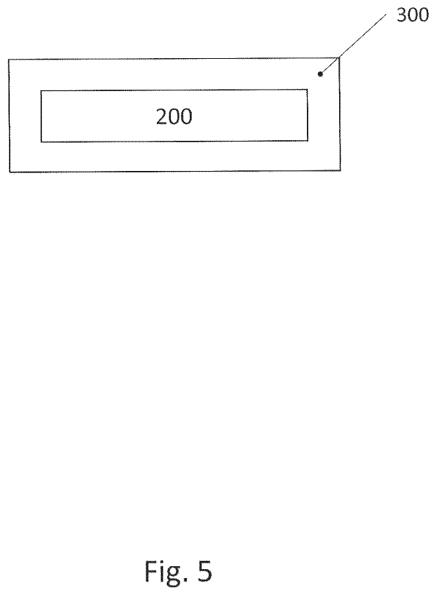

FIG. 5 shows a schematic illustration of a computer-readable medium according to the invention.

FIG. 1 shows a block diagram of a method 100 for acoustically monitoring a measuring point 6 at a fitting 2 through which fluid flows, in particular at a condensate drain 4, which is shown in FIG. 2. The method 100 has the steps of: detecting 102 an ambient noise sound emission S_{U} in a surrounding area of the measuring point 6 shown in FIG. 2, detecting 104 a structure-borne sound emission S_{K}, which is emitted by the measuring point 6, determining 106a a first frequency spectrum 16a of the ambient noise sound emission S_{U} for a first frequency range 26a, which is shown in an exemplary manner in FIG. 3a. The method 100 further has the steps of: determining 106b at least one further frequency spectrum 16b of the ambient noise sound emission S_{U} for at least one further frequency range 26b, determining 108a a first frequency spectrum 18a of the structure-borne sound emission S_{K} for the first frequency range 26a as well as determining 108b at least one further frequency spectrum 18b of the structure-borne sound emission S_{K} for the at least one further frequency range 26b.

In the method step 110a, determining a first a first difference function 22a from the first frequency spectrum 16a of the ambient noise sound emission S_{U} and from the first frequency spectrum 18a of the structure-borne sound emission S_{K} takes place. Determining 110b at least one further difference function 22b from the further frequency spectrum 16b of the ambient noise sound emission S_{U} and the further frequency spectrum 18b of the structure-borne sound emission S_{K} further takes place. In the method step 112a, a first integer I1 is then determined from the first difference function 22a, and in the method step 112b, at least one further integer I2 of the further difference function 22b.

In the method steps 114a and 114b, determining a first characteristic number K1 then takes place on the basis of the first integer I1 and determining a further characteristic number K2 on the basis of the further integer I2. In the method step 116, determining an operating state B of the condensate drain 4 then takes place on the basis of the characteristic pattern 20, which is formed by the characteristic numbers K1 and K2. In the method step 118, a quantitatively determining of a derived steam loss and/or condensate amount lastly takes place on the basis of the characteristic pattern 20.

Determining the operating state B and the derived steam loss and/or condensate amount preferably takes place on the basis of the characteristic pattern 20 and of a temperature T of the condensate drain. Determining 116, 118 the operating state B and the derived steam loss and/or condensate amount from the characteristic pattern 20 in particular takes place on the basis of machine learning.

FIG. 2 shows an exemplary embodiment of a sensor device 1 for acoustically monitoring a measuring point 6 at a fitting 2 through which fluid flows, in particular at a condensate drain 4. The sensor device 1 has a sound sensor 8. The sound sensor 8 is configured to sense an ambient noise sound emission S_{U} in a contact-free manner. The sensor device 1 is further configured to sense a structure-borne sound emission S_{K}, which is emitted from a point 6, in a contact-free manner. The sensor device 1 furthermore has a control device 12, which is connected to the sound sensor 8 so as to carry data, wherein the control device 12 is configured to carry out the method 100 according to FIG. 1.

The sound sensor 8 is formed as broadband microphone 10, in particular as ultrasonic microphone 10. The sensor device 1 is formed as mobile device. The sensor device 1 further has a display means 14, which is formed as display 14. The display means 14 is configured to display the operating state B of the fitting 2 and/or the steam loss and/or condensate amount. The sensor device 1 further has a temperature sensor 28. The temperature sensor 28 is formed as infrared thermometer 30. The temperature sensor 28 is configured to sense a temperature T of the condensate drain 4, in particular to sense it in a contact-free manner. The temperature sensor 28 is connected to the control device 12 so as to carry data. The measurement of the ambient noise sound emission S_{U} thereby takes place at a first distance d_{U} from the measuring point 6. The measurement of the structure-borne sound emission S_{K} takes place at a second distance d_{K} from the measuring point 6. The second distance d_{K} is smaller than the first distance d_{U}. The first distance du from the measuring point is preferably 20 cm. A second measurement takes place subsequently at the second distance d_{K} from the measuring point 6 of in particular 5 cm.

As can be seen from FIG. 2, the sound sensor 8 or the ultrasonic microphone 10, respectively, is connected to a filter and amplifier 32 so as to carry data. An amplification and a filtering of the sound signal determined by means of the sound sensor takes place by means of the filter and amplifier 32. The filter and amplifier 32, in turn, is connected to an analog-to-digital converter 34. A conversion of the analog signal into a digital signal, which is then supplied to the control device 12, takes place by means of the analog-to-digital converter 34. The control device 12 is connected to a communication interface 36 so as to carry data. The communication interface 36 is configured to communicate with a cloud 38, a mobile device 40 and/or a computer 42 via a data network 44.

FIG. 3a shows a frequency spectrum 16 of an exemplary ambient noise sound emission S_{U} and a frequency spectrum 18 of a structure-borne sound emission S_{K}, wherein for the spectrums 16, 18, the frequency is applied via the sound pressure in a frequency range of 0 to 50 kHz. A first frequency spectrum 16a of the ambient noise sound emission S_{U} and a first frequency spectrum 18a of a structure-borne sound emission S_{K} can be determined for a first frequency range 26a. The same can be performed for the further frequency range 26b, which is drawn in an exemplary manner here, which has the frequency spectrums 16b and 18b. As shown in FIG. 3b, a difference function 22a is formed subsequently for the frequency spectrums 16a and 18a, the integer I1 of which, in turn, forms a first characteristic number K1. A difference function 22b is likewise formed for the further frequency range 26b, which is illustrated in an exemplary manner, the integer I2 of which forms the further characteristic number K2. The characteristic numbers K1 and K2 form a characteristic pattern 20. Further characteristic numbers Kn are furthermore drawn in FIG. 3b, which are formed from integers In and which can contribute to the characteristic pattern FIG. 4 shows a computer program 200. The computer program 200 comprises commands,

which have the effect that a sensor device 1 formed according to FIG. 2 carries out the method 100 according to FIG. 1. FIG. 5 shows a computer-readable medium 300. The computer program 200 according to FIG. 4 is stored on the computer-readable medium 300.

### LIST OF REFERENCE NUMERALS

1 sensor device
2 fitting
4 condensate drain
6 measuring point
8 sound sensor
10 ultrasonic microphone
12 control device
14 display means/display
16a first frequency spectrum of the ambient noise sound emission
16b further frequency spectrums of the ambient noise sound emission
18a first frequency spectrum of the structure-borne sound emission
18b further frequency spectrum of the structure-borne sound emission
20 characteristic pattern
22a first difference function
22b further difference function
26a first frequency range
26b further frequency range
28 temperature sensor
30 infrared thermometer
32 filter and amplifier
34 analog-to-digital converter
36 communication interface
38 cloud
40 mobile device
42 computer
44 data network
100 method
102 detecting an ambient noise sound emission
104 detecting a structure-borne sound emission
106a determining a first frequency spectrum of the ambient noise sound emission
106b determining a further frequency spectrum of the ambient noise sound emission
108a determining a first frequency spectrum of the structure-borne sound emission
108b determining a further frequency spectrum of the structure-borne sound emission
110a determining a first difference function
110b determining a further difference function
112a determining a first integer
112a determining a further integer
114a determining a first characteristic number
114b determining a further characteristic number
116 determining an operating state
118 determining a derived steam loss and/or condensate amount
200 computer program
300 computer-readable medium
B operating state of the fitting
dU distance from the measuring point for measuring the ambient noise sound emission
dk distance from the measuring point for measuring the structure-borne sound emission
K1 first characteristic number
K2 further characteristic number
Kn characteristic numbers
I1 first integer
I2 further integer
In characteristic integers
SU ambient noise sound emission
SK structure-borne sound emission
T temperature of the condensate drain

1. A method for acoustically monitoring a measuring point at a fitting through which fluid flows, in particular at a condensate drain, comprising the steps of:
detecting an ambient noise sound emission in a surrounding area of the measuring point;
detecting a structure-borne sound emission, which is emitted by the measuring point;
determining a first frequency spectrum of the ambient noise sound emission for a first frequency range;
determining at least one further frequency spectrum of the ambient noise sound emission for at least one further frequency range;
determining a first frequency spectrum of the structure-borne sound emission for the first frequency range;
determining at least one further frequency spectrum of the structure-borne sound emission for the at least one further frequency range;
determining a first characteristic number from the frequency spectrums in the first frequency range;
determining a further characteristic number from the further frequency spectrums in the further frequency range, wherein the characteristic numbers form a characteristic pattern,
determining an operating state of the condensate drain on the basis of the characteristic pattern.

2. The method according to claim 1,
wherein detecting the ambient noise sound emission and detecting the structure-borne sound emission take place in a contact-free manner.

3. The method according to claim 2,
wherein the ambient noise sound emission is detected at a first distance from the measuring point and wherein the structure-borne sound emission is detected at a second distance from the measuring point, wherein the second distance is smaller than the first distance.

4. The method according to claim 3,
wherein the first distance from the measuring point is 10 cm to 30 cm, in particular 20 cm.

5. The method according to claim 3,
wherein the second distance from the measuring point is 1 cm to 10 cm, in particular 5 cm.

6. The method according to claim 1, further comprising the steps of:
determining a first a first difference function from the first frequency spectrum of the ambient noise sound emission and from the first frequency spectrum of the structure-borne sound emission,
determining at least one further difference function from the further frequency spectrum of the ambient noise sound emission and the further frequency spectrum of the structure-borne sound emission,
determining the first characteristic number on the basis of the first difference function, determining the further characteristic number on the basis of the further difference function.

7. The method according to claim 6,
further comprising the steps of:
determining a first integer of the first difference function,
determining at least one further integer of the further difference function,
determining the first characteristic number on the basis of the first integer, determining the further characteristic number on the basis of the further integer.

8. The method according to claim 1,
wherein determining an operating state of the condensate drain on the basis of the characteristic pattern comprises at least one of the following operating states: normal operation of the condensate drain, defect of the condensate drain.

9. The method according to claim 1,
further comprising the step of:
quantitatively determining at least one of a derived steam loss and condensate amount on the basis of the characteristic pattern.

10. The method according to claim 9,
further comprising the step of:
providing or detecting a temperature of the condensate drain, in particular at the measuring point, wherein determining at least one of the operating state, the derived steam loss, and condensate amount takes place on the basis of the characteristic pattern and of the temperature.

11. The method according to claim 9,
wherein determining the operating state and at least one of the derived steam loss and condensate amount from the characteristic pattern takes place on the basis of machine learning.

12. A sensor device for acoustically monitoring a measuring point at a fitting through which fluid flows, in particular at a condensate drain, comprising
a sound sensor, which is configured to sense an ambient noise sound emission and a structure-borne sound emission, which is emitted by the measuring point, in a contact-free manner,
a control device, which is connected to the sound sensor so as to carry data, wherein the control device is configured to carry out the method according to claim 1.

13. The sensor device according to claim 12,
wherein the sound sensor is formed as broadband microphone, in particular ultrasonic microphone.

14. The sensor device according to claim 12,
wherein the sensor device is formed as mobile device.

15. The sensor device according to claim 12,
wherein the sensor device has a display means, in particular a display, which is configured to display the operating state of at least one of the fitting, the steam loss, and condensate amount.

16. The sensor device according to claim 12,
further having a temperature sensor, in particular an infrared temperature sensor, wherein the temperature sensor is configured to sense a temperature of the condensate drain, in particular to sense it in a contact-free manner, and wherein the temperature sensor is connected to the control device so as to carry data.

17. A computer program, comprising commands, which have the effect that a sensor device carries out the method according to claim 1.

18. A computer-readable medium, on which the computer program according to claim 17 is stored.
